(19) United States
(12) Patent Application Publication
(10) Pub. No.: US 2009/0007855 A1
(43) Pub. Date: Jan. 8, 2009

(54) Animal Harness

(76) Inventors: Lloyd Alvin Alexander, Elm Mott, TX (US); Harold Lee Alexander, Waco, TX (US)

Correspondence Address: AARON M. WILKERSON, P.O. BOX 588, CHINA SPRING, TX, 76633, US

(21) Appl. No.: 11/773,537

(22) Filed: Jul. 5, 2007

(51) Int. Cl. A01K 15/02

(52) U.S. Cl. 119/792

(57) ABSTRACT

An improved animal harness including a body strap for extending around the body of an animal behind its front legs, the body strap having a plurality of body strap peripheral openings centered on the body strap. The body strap has a closing means for securing a first end of the body strap to a second end of the body strap. The body strap is secured by a fastening means to a chest strap for extending around the chest of the animal, the chest strap having a plurality of chest strap peripheral openings being spaced apart a sufficient distance on the chest strap to allow adjustability of the animal harness. An upper edge of the chest strap forms an inverted arch beginning at a left chest strap position and terminating at a right chest strap position to accommodate the natural curvature of the animal's chest. In addition, a leash attachment means is attached to the body strap.

### BACKGROUND

Humane and safe animal handling and humane and safe animal restraint are both vital components in the daily interaction between humans and animals. The first component, safe and effective animal handling, requires an understanding of the normal behavior and responses of the particular species of animal. Once this understanding is attained, the second component, humane and safe animal restraint, should be achieved. This second component in the daily interaction between humans and animals, humane and safe animal restraint, is the subject of this application.

Various animal restraint mechanisms exist, which incorporate a wide spectrum of control-imposing philosophies. On one end of the spectrum, it is not uncommon for animal handlers to utilize a cruel training restraint apparatus to control the animal, in many instances risking physical harm, discomfort or injury to the animal and teaching the animal obedience through the animal's recognition of pain. At the opposite end of the spectrum, animal handlers interact with the animal while utilizing no restraint mechanisms of any kind on the animal. This philosophy suffers from the risks of the animal easily escaping or the animal becoming confused, frightened or aggressive, thus placing the safety of the animal handler, the animal, and others in the vicinity in danger. Restraint mechanisms existing in the middle of the spectrum are apparatuses that are flimsy, expensive to manufacture, ineffective, unsafe, cruel and difficult to apply to the animal.

Information relevant to attempts to address the above-referenced problems can be found in U.S. Pat. Nos. 7,107,939 to Lady (2006), 5,247,905 to Arakawa (1993), 3,768,445 to Sorrels (1973), 6,662,755 to Kato (2003), 6,213,057 to Franco (2001), 7,004,113 to Zutis (2006), 5,370,083 to Sporn (1994), 5,443,037 to Saleme (1995), 4,060,056 to Maietta (1976), 4,559,906 to Smith (1985), 5,911,200 to Clark (1999) and 6,463,888 to Clark (2002). However, each one of these references suffers from one or more of the following disadvantages:
1. difficult application of the restraint apparatus to the animal;
2. failure of comfortable movement of the animal because of mechanical inflexibility of the restraint apparatus;
3. failure of comfortable movement of the animal because of operational inflexibility of the restraint apparatus;
4. reduced width of the sections of the restraint apparatus, causing discomfort or pain to the animal;
5. if the animal goes wild, the restraint apparatus may become loose or unfastened, allowing the animal to escape;
6. the cost to produce the animal restraint apparatus is expensive;
7. the restraint apparatus is complicated;
8. the restraint apparatus imposes a physical burden on the anal;
9. the restraint apparatus has more than one point of closure, thus increasing time of application;
10. the restraint apparatus is applied to the animal over the animal's head;
11. the restraint apparatus is likely to move laterally or longitudinally from its desired position on the animal;
12. the restraint apparatus causes physical pain, discomfort or harm to the animal;
13. the restraint apparatus is flimsy.

For the foregoing reasons, there is a need for a sturdy, safe, cruelty-free, efficient and effective restraint of animals, particularly domesticated animals.

### SUMMARY

The present invention is directed to an improved animal harness that satisfies these needs. An improved animal harness having features of the present invention comprises a body strap for extending around the body of an animal behind its front legs adjustably attached to a chest strap for extending around the animal's chest. The chest strap and body strap are comprised of a lightweight, sturdy, flexible material, such as leather or nylon. The body strap has a closing means for securing on the animal's back a first end of the body strap to a second end of the body strap. The closing means can include a clip, a fastener, a piece of fabric of small hooks that sticks to a corresponding fabric of small loops or a fastening for two loose ends that is attached to one and holds the other by a catch. The chest strap has a plurality of chest strap peripheral openings located near each end of the chest strap, the chest strap peripheral openings being sized equally to a plurality of body strap peripheral openings centered on the body strap. The chest strap peripheral openings are spaced apart a sufficient distance on the chest strap to allow adjustability of the animal harness. The chest strap peripheral openings and the body strap peripheral openings are aligned to comfortably accommodate the size of the animal. When the chest strap peripheral openings and the body strap peripheral openings are aligned, the openings are secured by a fastener such as a screw or a snap to fix the size of the animal harness. As the chest strap extends around the animal's chest, the upper edge of the chest strap forms an inverted arch beginning at a left chest strap position and terminating at a right chest strap position to accommodate the natural curvature of the animal's chest, allowing for a comfortable fit on the animal. A leash attachment means is attached to the body strap at the point of the closing means.

Accordingly, several objects and advantages of the present invention are (a) to provide an inexpensively manufactured animal harness; (b) to provide an adjustable animal harness; (c) to provide an animal harness that is easily applied to and is easily removed from the animal; (d) to provide an animal harness that is simple in design and simple to manufacture; (e) to provide an animal harness that is lightweight; (f) to provide an animal harness that does not go over the animal's head; (g) to provide an animal harness that closes on the animal's back; (h) to provide an animal harness that is sturdy, rugged and stable; (i) to provide an animal harness that causes little discomfort to the animal.

### BRIEF DESCRIPTION OF THE DRAWINGS

These and other features, aspects, and advantages of the present invention will become better understood with regard to the following description, appended claims, and accompanying drawings where:

FIG. 1 shows a perspective view of the animal harness;

FIG. 2 shows a front view of the improved animal harness as it would be worn by a dog;

FIG. 3 shows a left side view of the animal harness as it would be worn by a dog;

FIG. 4 shows a left side view of the animal harness being fitted to a dog;

FIG. 5 shows a perspective view of the peripheral openings of the body strap being aligned with the peripheral openings of the chest strap;

FIG. 6 shows a perspective view of the body strap being connected to the chest strap using a fastener;

FIG. 7 shows left side view of the animal harness after being stepped into by a dog.

### DESCRIPTION

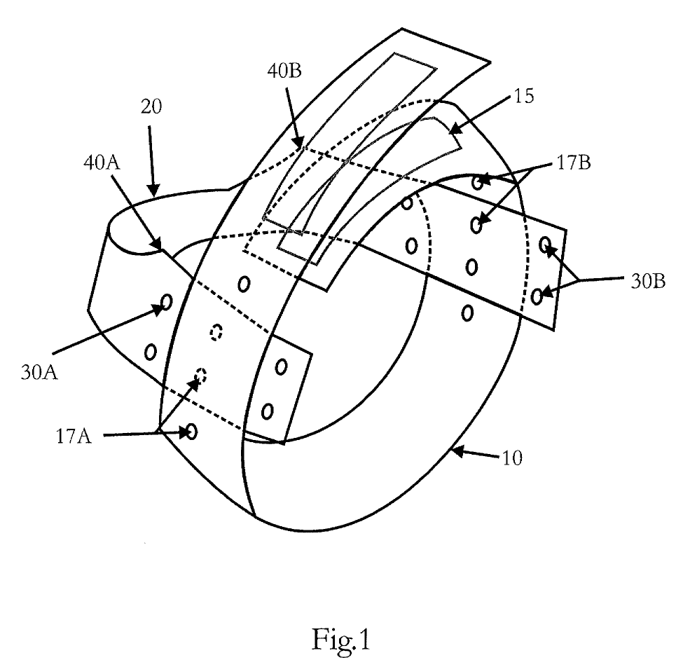

As shown in FIG. 1, an improved animal harness comprises a vertically situated body strap 10 adjustably attached to a horizontally situated chest strap 20. The body strap 10 and chest strap 20 are preferably made of lightweight, sturdy, flexible material such as leather or nylon. The body strap 10 extends around the body of an animal behind its front legs and is secured by a body strap closing means 15 such as a clip, a fastener, a piece of fabric of small hooks that sticks to a corresponding fabric of small loops or a fastening for two loose ends that is attached to one and holds the other by a catch. The body strap 10 includes a plurality of vertically positioned body strap left peripheral openings 17A located in the center of the body strap 10, positioned on the left side of the animal's body. The body strap 10 also includes a plurality of vertically positioned body strap right peripheral openings 17B located in the center of the body strap 10, positioned on the right side of the animal's body.

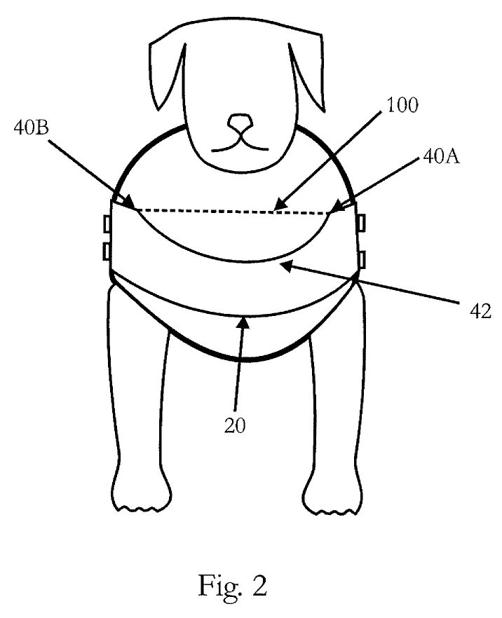

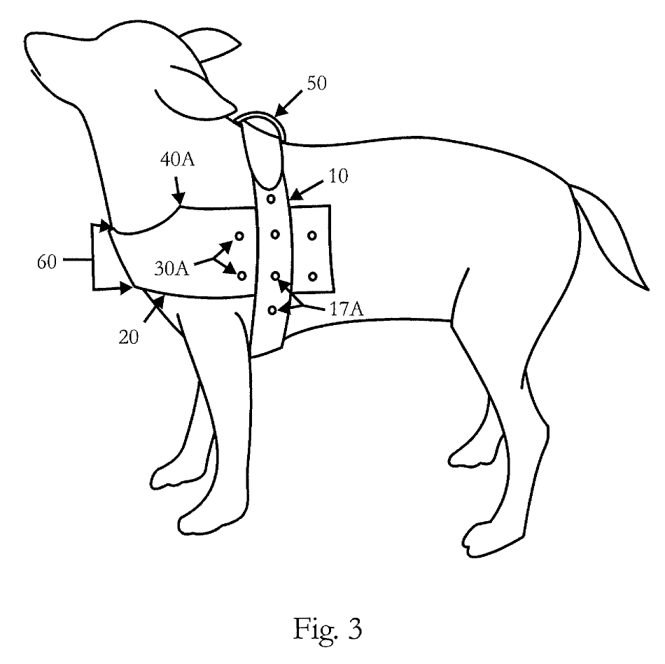

As further shown on FIG. 1, chest strap 20 includes a plurality of chest strap left peripheral openings 30A, horizontally positioned along the left side of chest strap 20. The chest strap 20 also includes a plurality of chest strap right peripheral openings 30B, horizontally positioned along the tight side of the chest strap 20. As shown on FIG. 2, a dashed line 100 defines a x-axis between a left chest strap position 40A and a right chest strap position 40B. An upper edge 42 of the chest strap 20 forms an inverted arch beginning at a left chest strap position 40A and terminating at a right chest strap position 40B to accommodate the natural curvature of the animal's chest. As shown on FIG. 3, a leash attachment means 50, such as a ring or loop is attached to the body strap 10 directly above the animal's withers to allow for attachment of a leash to the animal harness.

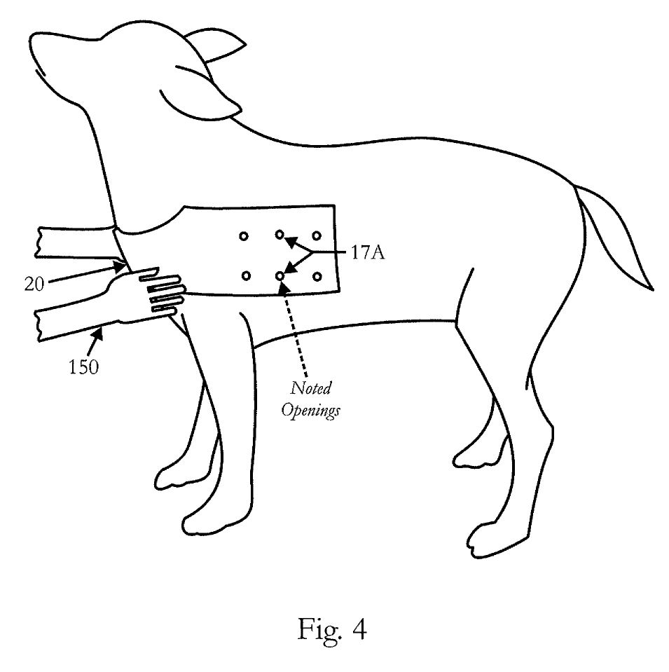

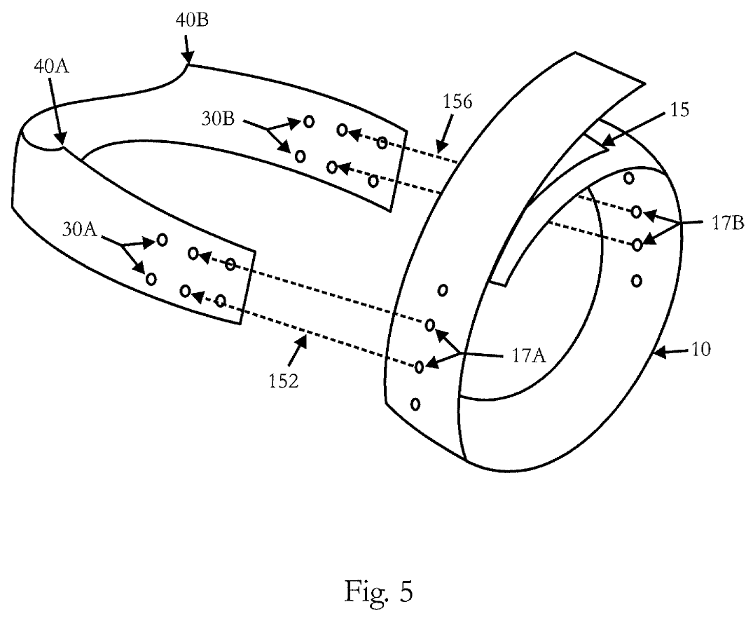

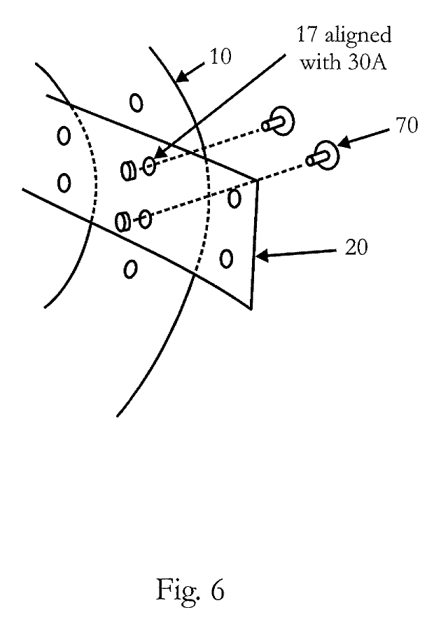

FIG. 4 shows how to adjust the sizing of the animal harness. In a first step 150, center the chest strap 20 on the animal's chest and note the chest strap left peripheral openings 17A that align on a vertical plane behind and substantially parallel to the animal's left front leg. Similarly, when the chest strap 20 is centered on the animal's chest, note the chest strap right peripheral openings 17B that align on a vertical plane behind and substantially parallel to the animal's right front leg. Once the correct openings are noted, remove the chest strap 20 from the animal's chest. In a second step 152, as shown on FIG. 5, align the previously noted chest strap left peripheral openings 17A with the body strap left peripheral openings 30A. In a third step 154, as shown on FIG. 6, insert a fastener 70 such as a screw or a snap through the aligned chest strap peripheral openings 17A and body strap peripheral openings 30A to attach the chest strap 20 to the body strap 10. Similar to the second step 152, in a fourth step 156, as shown on FIG. 5, align the previously noted chest strap right peripheral openings 17B with the body strap right peripheral openings 303. Similar to the third step 154, insert a fastener 70 such as a screw or a snap through the aligned chest strap peripheral openings 17A and body strap peripheral openings 30A to attach the chest strap 20 to the body strap 10.

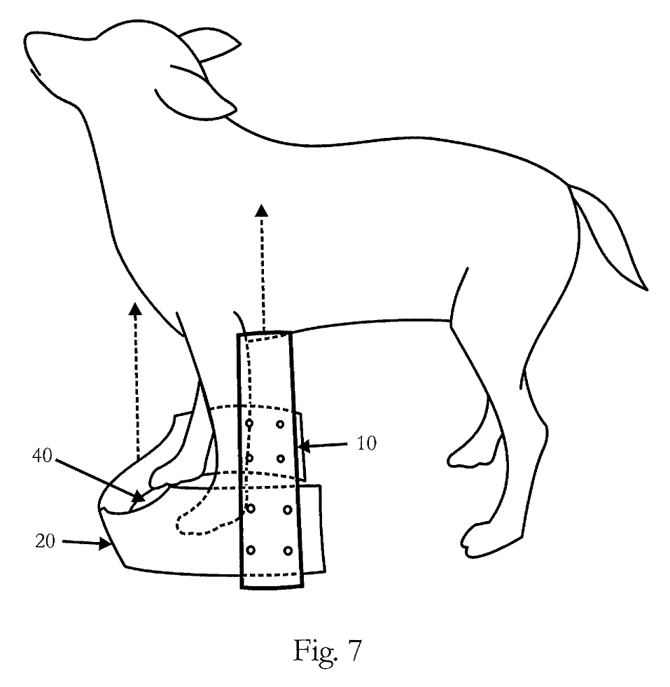

FIG. 7 illustrates the application of the animal harness to an animal, such as a dog. Place the dog's front feet through the opening 40 formed between the chest strap 20 and the body strap 10. Lift the chest strap 20 onto the animal's chest to a resting position 60 shown in FIG. 3 and attach closing means 15 on the body strap 10. Assuming that the closing means 15 is not faulty, the animal harness, when fitted properly, should be almost escape proof.

To remove the animal harness, release the closing means 15 and allow the animal harness to drop to the ground. The animal can then walk out of the animal harness.

Thus the reader will see that this animal harness is inexpensive, sturdy, rugged and stable. It attaches and releases very quickly. It has only one point of closure on an animal's back. With a proper closing means, it is very secure against escape. This animal harness is adjustable, very easy to apply and very easy to remove from the animal. It is simple in design and simple to manufacture. It can be stored compactly, is lightweight and can be made in a variety of colors. When properly adjusted, it causes little, if any, discomfort to the animal. This animal harness is not applied by going over the animal's head.

Although the description above contains many specifications, these should not be construed as limiting the scope of the present invention. They merely provide illustrations of some of the presently preferred embodiments of the present invention. For example, the closing means could be of varying materials, shapes, sizes and colors. The body strap and the chest strap could be of varying widths, lengths, colors and materials. The fastener could be of varying materials, shapes, sizes and colors.

It will further be understood that various changes in the details, materials and arrangements of the parts and parameters which have been described and illustrated to explain the nature of the invention may be made by those skilled in the art without departing from the principle and scope of the invention. Therefore, the spirit and scope of the appended claims should not be limited to the description of the preferred versions contained herein.

What is claimed is:

1. An improved animal harness comprising:
a body strap for extending around the body of an animal behind its front legs, the body strap having a plurality of body strap peripheral openings centered on the body strap;
a body strap closing means for securing a first end of the body strap to a second end of the body strap;
a chest strap for extending around the chest of the animal, the chest strap having a plurality of chest strap peripheral openings centered on the chest strap and being spaced apart a sufficient distance on the chest strap to allow adjustability of the animal harness;
a fastening means to secure the body strap to the chest strap; and
a leash attachment means attached to the body strap.

2. The improved animal harness of claim 1, wherein an upper edge of the chest strap forms a narrowing inverted arch to allow for natural curvature of the animal's neck.

3. The improved animal harness of claim 1, wherein the body strap peripheral openings comprise at least two openings.

4. The improved animal harness of claim 1, wherein the body strap and the chest strap are secured together by the steps of aligning the body strap peripheral openings with the chest strap peripheral openings and then inserting a fastening means therethrough.
